(19) United States
(12) Patent Application Publication
(10) Pub. No.: US 2005/0219450 A1
(43) Pub. Date: Oct. 6, 2005

(54) Electro-optical device and electronic apparatus

(76) Inventors: Chihiro Tanaka, Matsumoto-shi (JP); Masahiro Horiguchi, Matsumoto-shi (JP); Tadashi Tsuyuki, Okaya-shi (JP)

Correspondence Address: HARNESS, DICKEY & PIERCE, P.L.C., P.O. BOX 828, BLOOMFIELD HILLS, MI, 48303, US

(21) Appl. No.: 11/094,796

(22) Filed: Mar. 30, 2005

(30) Foreign Application Priority Data
Mar. 31, 2004 (JP) 2004-103419
Feb. 25, 2005 (JP) 2005-050340

(51) Int. Cl. G02F 1/1343

(52) U.S. Cl. 349/139

(57) ABSTRACT

An electro-optical device includes a substrate, first and second conductive layers, switching elements formed on the substrate and having an insulating layer interposed between the first conductive layer and the second conductive layer, signal lines formed on the substrate that supply signals to the switching elements, an interlayer insulating layer formed on the substrate so as to cover the signal lines and the switching elements, and pixel electrodes formed on the interlayer insulating layer and electrically connected to the switching elements. The switching elements are nonlinear elements, and the signal lines and the pixel electrodes overlap in plan view.

### BACKGROUND OF THE INVENTION

1. Technical Field

The present invention relates to an electro-optical device and an electronic apparatus.

2. Related Art

Conventionally, two-terminal-type nonlinear elements as switching devices for use in electro-optical devices such as liquid crystal devices have been known, and these elements have a construction as disclosed in the related art. Japanese Unexamined Patent Application Publication No. 8-211410 and Japanese Unexamined Patent Application Publication No. 11-153804 are example of the related art.

In the related art, a liquid crystal device having an MIM element as a two-terminal-type nonlinear element is disclosed, and the MIM element and a pixel electrode are connected with an insulating layer interposed therebetween. However, according to the above construction of the related art, data lines and pixel electrodes for driving the MIM element are formed at different regions in plan view, so that in this case, the data line is not formed in a region where the data line is formed and thus a sufficient aperture ratio cannot be obtained.

In addition, in the related art, each of the data lines are formed between two pixel electrodes, i.e., one pixel electrode is interposed between different data lines. In this case, there may be parasitic capacitances between the pixel electrode and each data line having the pixel electrode interposed therebetween. Like this, when parasitic capacitance is generated between different data lines with respect to one pixel electrode, the operation of the pixel electrode may be disturbed and furthermore, the reliability of the electro-optical device may be lowered. In other words, when each different pulse signal is conducted on each data line, parasitic capacitance is generated between each data line at different timing, also causing a disturbance of the operation of the pixel electrode.

### SUMMARY

An advantage of the invention is that it provides an electro-optical device having a nonlinear element in an arrangement where stable driving can be executed, whereby an electro-optical device having high reliability is provided. In addition, when the electro-optical device is used as a display device, the aperture ratio can be increased. Moreover, another advantage of the invention is that it also provides a highly reliable electronic apparatus having the electro-optical device described above.

According to an aspect of the invention, there is provided an electro-optical device includes a substrate, first and second conductive layers, switching elements formed on the substrate and having an insulating layer interposed between the first conductive layer and the second conductive layer, signal lines formed on the substrate that supply signals to the switching elements, an interlayer insulating layer formed on the substrate so as to cover the signal lines and the switching elements, and pixel electrodes formed on the interlayer insulating layer and electrically connected to the switching elements. The switching elements are nonlinear elements, and the signal lines and the pixel electrodes overlap in plan view.

With the electro-optical device described above, an interlayer insulating layer is formed to cover the nonlinear elements serving as a switching elements, and the signal lines, and the pixel electrodes are formed on the interlayer insulating layer. Therefore, a parasitic capacitance between the pixel electrodes and the switching elements and/or the signal lines can be reduced.

In addition, the pixel electrodes and the switching elements and/or the signal lines are laminated with the interlayer insulating layer interposed therebetween, so that the pixel electrodes can be arranged to cover the switching elements and/or the signal lines. Thus, comparing with a case where the pixel electrodes are formed on the same plane as the switching elements and/or the signal lines, the pixel electrodes may be largely formed, and further, may take a large effective pixel region.

In addition, since the pixel electrodes are formed to cover the signal lines, in particular, comparing with a case where the signal lines are arranged between adjacent pixel electrodes, driving of the pixel electrode can be stabilized. In other words, as described above, the signal lines and the pixel electrodes are formed with the interlayer insulating layer interposed therebetween so that a parasitic capacitance that may be generated therebetween can be reduced. However, even when driving of the pixel electrode is disturbed due to the parasitic capacitance, this disturbance can be reduced. More specifically, when the pixel electrodes are arranged between two signal lines as in the related art, a large disturbance in driving the pixel electrode is caused by the parasitic capacitance between each signal line. However, according to the aspect of the invention, when the pixel electrodes are arranged to cover the signal lines, only the parasitic capacitance between the pixel electrode and the signal line covered therewith substantially affects the driving. Thus, the disturbance herein can be suppressed.

As a result brought by the afore-mentioned advantages, it is possible to provide an electro-optical device having a high reliability. In particular, when it is used as a display device, it is impossible to realize a display having a large aperture ratio and an excellent visibility.

In the electro-optical device according to the aspect of the invention, the signal lines may be arranged at the same distance from a second pixel electrode and a third pixel electrode, respectively, both adjacent to a first pixel electrode arranged to be overlapped in plan view with the signal line. In this case, the driving of the first pixel electrode is affected only by the parasitic capacitance between the first pixel electrode and the signal line covered thereby, so that the parasitic capacitance between the second and third pixel electrodes and the signal lines arranged to be overlapped in plan view is significantly small and is little affected. Therefore, the disturbance of operation of the pixel electrode is reduced so that it is possible to provide an electro-optical device having a high reliability.

In addition, with the electro-optical device described above, the switching elements and the pixel electrodes may be connected via a contact hole formed in the interlayer insulating layer, and wiring lines arranged to extend from the switching elements to the contact holes may be formed on the substrate to cover the interlayer insulating layer, and the switching element may be electrically connected to the pixel electrode via the wiring line. With this wiring line formed, the electrical connection can be reliably performed from the switching device to the contact hole.

In this case, the wiring line may have a larger area than an aperture area of the contact hole right below the contact hole. With this arrangement, it can be guaranteed that the formation region of the contact hole is blocked at the wiring line.

The light-shielding layer extending parallel to the signal lines may be formed between the adjacent pixel electrodes such that the light-shielding layer is made of the same material as the signal wiring line and is formed on the same plane. In this case, it is ensured that the light-shielding layer blocks light between the adjacent pixel electrodes while the light-shielding layer is formed through the same process as the forming process of the signal line, thus attributing to manufacturing efficiency and cost reduction.

The electro-optical device may further include a counter substrate facing the substrate, and a liquid crystal having a negative dielectric anisotropy may be interposed between the substrate and the counter substrate.

Further, the wiring lines may be formed in a shape based on appearance of the contact hole around the contact holes. Specifically, the wiring lines around the contact hole may be formed in a planar shape based on the axial cross section of the contact hole. In this case, the region of the wiring line is significantly reduced while sufficiently accomplishing the light blocking effect of the afore-mentioned contact hole.

The interlayer insulating layer may be a planarizing layer. Specifically, the interlayer insulating layer may be formed in a flat surface. In this case, for example, when the electro-optical device is used as a liquid crystal device, alignment disturbance of the liquid crystal can be efficiently prevented or suppressed, and in particular, a region where the wiring line and element are not formed can be planarized. Thus, it is advantageous in suppressing the alignment disturbance of the liquid crystal.

A distance between adjacent signal lines that are not electrically connected to the pixel electrode and the wiring line may be larger than that between the adjacent signal line and the pixel electrode. Specifically, with respect to a positional relationship between one pixel electrode (referred to as the first pixel electrode) and the wiring line for supplying a signal hereto and a signal line (referred to as the second signal line) for supplying a signal to the second pixel electrode, a distance between the wiring line and the second signal line may be formed to be larger than a distance between the first pixel electrode and the second signal line. In this case, through a parasitic capacitance between the wiring line and the second signal line, it can be prevented or suppressed that the signal conducting the second signal line is carried along the wiring line.

An electro-optical device according to another aspect of the invention includes a first substrate and a second substrate facing each other, switching elements formed on the first substrate, signal lines formed on the first substrate and connected to the switching element, an interlayer insulating layer formed on the first substrate so as to cover the signal lines and the switching elements, pixel electrodes formed on the interlayer insulating layer and electrically connected to the switching elements via a contact holes, and a light-shielding layer formed on the second substrate and overlapping the contact holes in plan view. In this case, the signal lines and the pixel electrodes overlap.

Next, an electronic apparatus according to still another aspect of the invention includes the electro-optical device described above. Here, the electronic apparatus may be, for example, a cellular phone, a portable digital assistant, a word processor, a PC, and the like. Such electronic apparatus is used in the electro-optical device described above, leading to high reliability using stable driving. Thus, with the electro-optical device used as a display unit, a display having a large effective pixel region and high visibility can be provided.

### BRIEF DESCRIPTION OF THE INVENTION

The invention will be described with reference to the accompanying drawings, wherein like numbers reference like elements, and wherein:

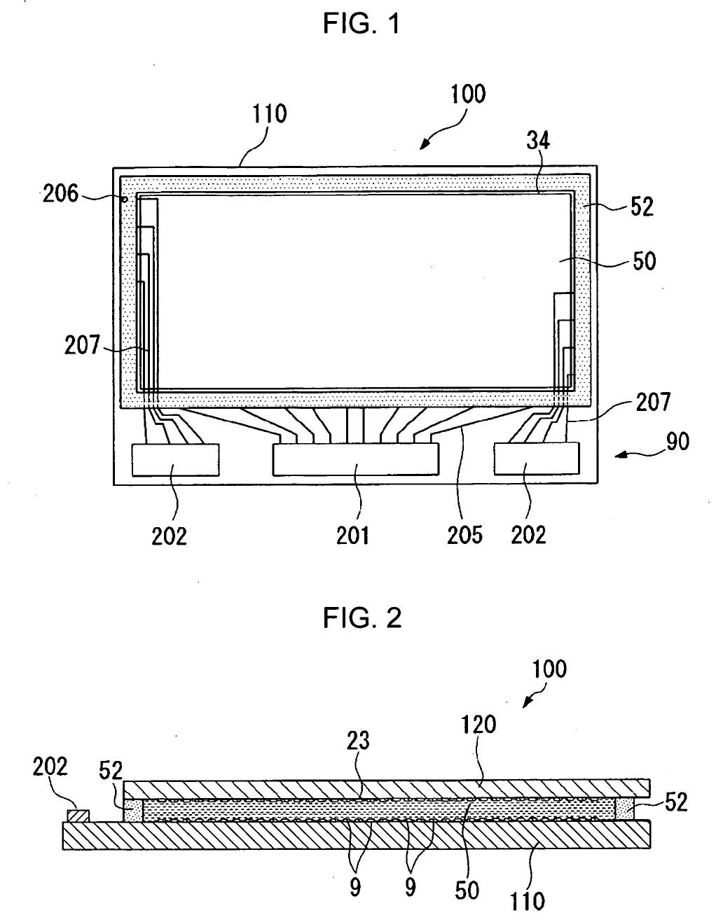

FIG. 1 is a plan view a liquid crystal device, as an electro-optical device according to an embodiment of the invention;

FIG. 2 is a cross-sectional view for an overall liquid crystal display device of FIG. 1;

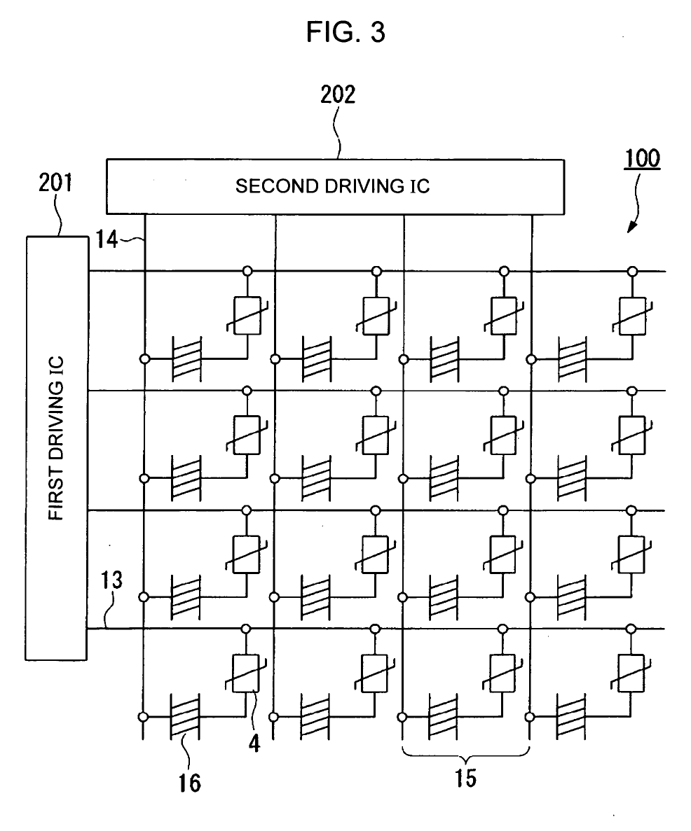

FIG. 3 is an equivalent circuit diagram of a liquid crystal display device of FIG. 1;

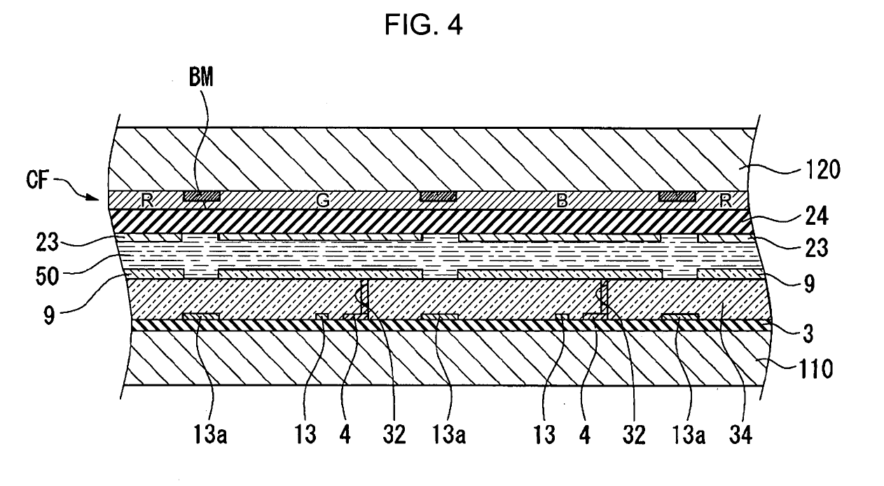

FIG. 4 is a schematic diagram showing a cross sectional arrangement for an essential part of the liquid crystal display device of FIG. 1;

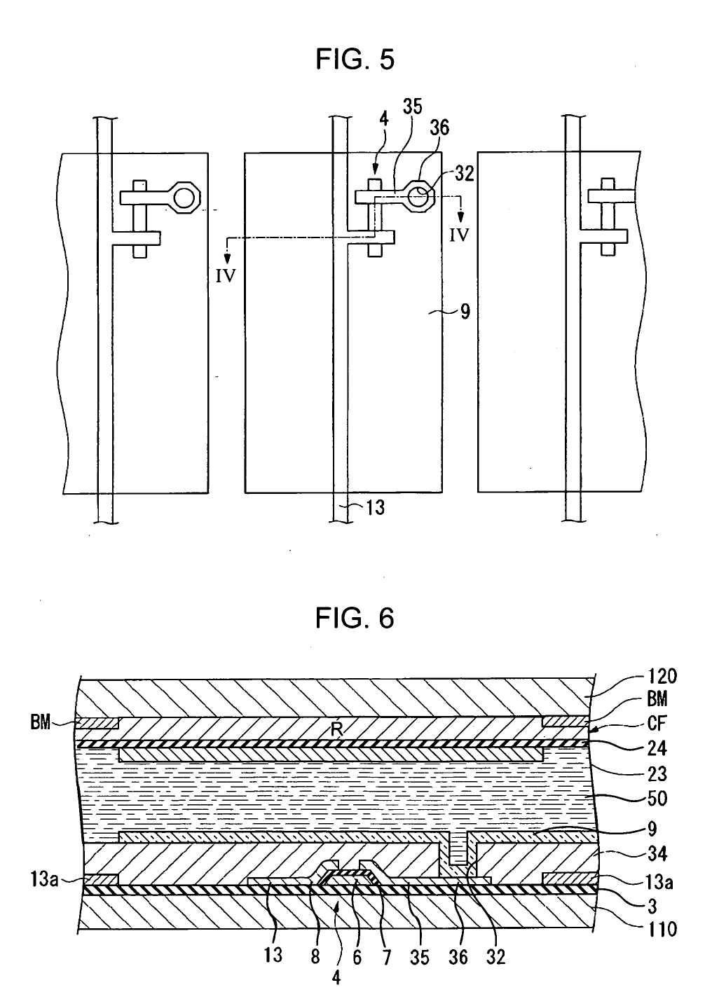

FIG. 5 is a schematic plan view illustrating a pixel arrangement of the liquid crystal display device of FIG. 1;

FIG. 6 is a schematic cross section illustrating a pixel arrangement of the liquid crystal display device of FIG. 1;

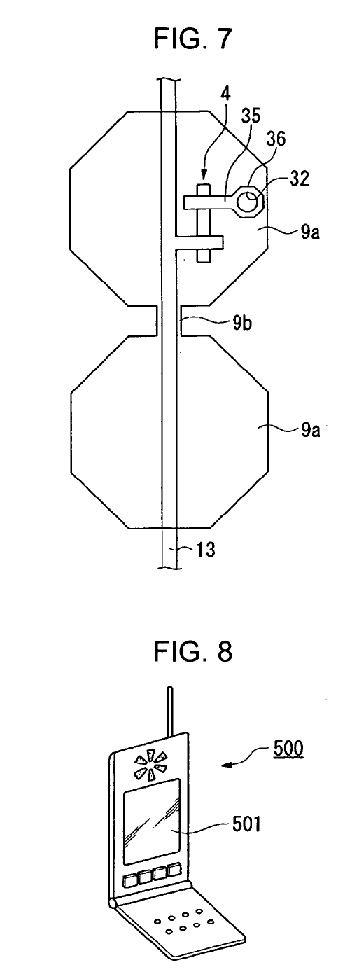

FIG. 7 is a schematic plan view illustrating a modified example of a pixel arrangement of the liquid crystal display. device of FIG. 1;

FIG. 8 is a perspective view illustrating an example of an electronic apparatus according to the invention;

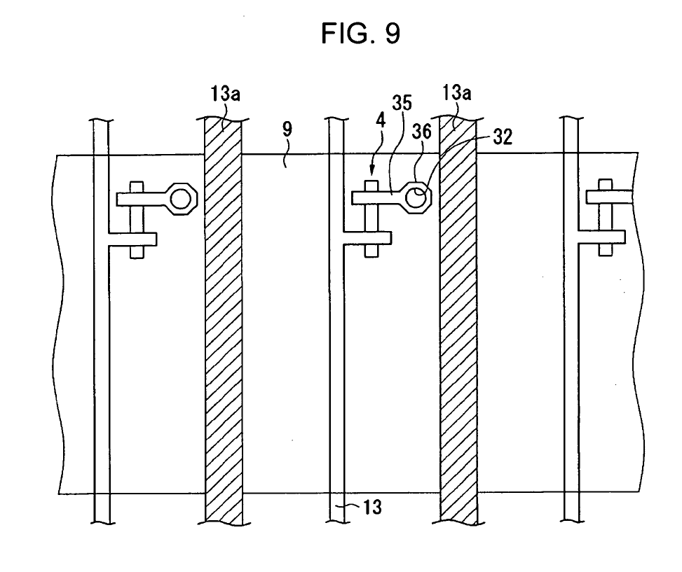

FIG. 9 is a schematic plan view illustrating an arrangement of a light-shielding layer formed on an inner surface of a lower substrate; and

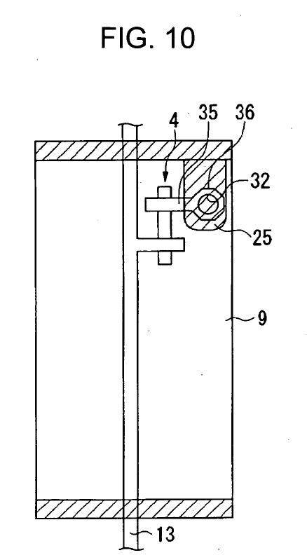

FIG. 10 is a schematic plan view illustrating an arrangement of a light-shielding layer formed on an inner surface of an upper substrate.

### DESCRIPTION OF THE EMBODIMENTS

Next, preferred embodiments of the invention will be described with reference to the accompanying drawings. In addition, the scale of each layer or member is adjusted in order to be a recognizable in the drawings.

Electro-optical Device

FIG. 1 is a plan view of a liquid crystal device, shown with respective elements, which is an electro-optical device according to an embodiment, seen from a counter substrate, and FIG. 2 is a cross-sectional view of an essential unit of FIG. 1. FIG. 3 is an equivalent circuit diagram, such as various elements and wiring lines for a plurality of elements formed in a matrix, in an image display region of the liquid crystal device. Here, the electro-optical device of this embodiment is a transmissive liquid crystal display device using light from a backlight unit (not shown), which is an active-matrix-type liquid crystal display device using two-terminal-type non-linear elements, such as thin film diodes (TFDs) as switching elements.

As shown in FIGS. 1 and 2, a liquid crystal display device 100 of the embodiment has a pair of substrates, i.e., a lower substrate 110 and an upper substrate 120, attached by a UV curable sealant 52, and liquid crystal 50 is filled and held in a region surrounded by the sealant 52. The sealant 52 is formed in a closed circular shape (frame shape) on the substrate without a liquid crystal inlet. In other words, the entire circular shape is continuously formed with the same material without providing a sealing member that seals a liquid crystal inlet. A sealant having a liquid crystal inlet and sealed using the sealing member may be used.

In a portion of the circular shaped sealant 52 which is provided along the right and left sides (two sides facing each other) of the lower substrate 110 shown in FIG. 1, conductive particles (conductive portion between substrates) 206 are contained for electrically connecting the lower substrate 110 and the upper substrate 120. In addition, the conductive particles 206 include anisotropic conductive particles.

A plurality of pixel electrodes 9 are formed in a matrix on an inner surface of the substrate 110 while rectangular shaped stripe electrodes 23 are formed on an inner surface of the substrate 120. On the inner surfaces of respective electrodes 9 and 23, an alignment layer (not shown) is further formed. In addition, the TFD elements 4 (thin film diode elements, see FIG. 4) are connected to the pixel electrodes 9 serving as switching elements.

In addition, according to the embodiment, the size of the lower substrate 110 is larger than that of the upper substrate 120, and the edges (end faces of the substrate) at three sides of the upper substrate 120 and the lower substrate 110 (an outer side, a right side and a left side) are substantially aligned while the edge of the lower substrate 110 extends from the remaining one side of the upper substrate 120 (the lower side of FIG. 1) to form an extending region 90.

In the extending region 90, a first drive IC 201 for driving pixel electrodes 9 formed on the lower substrate 110 and a second drive IC 202 for driving stripe electrodes 23 formed on the upper electrode 120 are mounted. In addition, an external connection terminal (not shown) is formed on each drive IC 201 and 202, so that display control signals can be received from an external apparatus other than the liquid crystal -display device 100.

Both the first drive IC 201 and the second drive IC 202 are arranged on the lower substrate 110, and are both formed in the extending region 90 of the rectangular lower substrate 110. The first drive IC 201 is an IC for transmitting signals to the TFD elements 4 (see FIG. 4), and further, the pixel electrodes 9 through signal lines formed on the lower substrate 110, and the signals are supplied through wiring lines 205 formed on the lower substrate 110.

The second drive IC 202 is formed on the lower substrate 110 and is used to transmit signals to the stripe electrodes 23 formed on the upper substrate 120, so that the signals are supplied to the stripe electrode 23 through the routing wiring lines 207 formed on the lower substrate 110 as well as the conductive particles 206 formed in the sealant 52. Here, the routing wiring lines 207 are connected to the conductive particles 206 from the inside of the circular shaped sealant 52 over the lower side of the sealant 52 shown in FIG. 1.

Electrical conduction between the upper and lower substrates is performed as follows.

First, the stripe electrodes 23 formed on the upper substrate 120 extend such that one end or both ends thereof penetrate into the sealant 52, and are electrically connected to the conductive particles 206 inside the sealant 52.

Further, on the side of the lower substrate 110, the routing wiring lines 207 connected to the afore-mentioned second drive IC 202 are formed, and the routing wiring lines 207 are bent to extend from the second drive IC 202 mounted on the extending region 90 at the lower side of the lower substrate 110 to the left and right sides of the lower substrate 110, as shown in FIG. 1. Further, at the lower side of the lower substrate 110, the routing wiring lines 207 cross over the sealant 52 and extend to the inner region of the sealant 52 along the left and right sides of the lower substrate 110 in a longitudinal direction. In addition, in a position connected to a predetermined stripe electrode 23, the routing wiring line 207 conducts inside the sealant 52 and is thus electrically connected to the conductive particles 206.

Here, the conductive particles 206 are made of anisotropic conductive particles, and are arranged in a shape that can be elastically deformed upward and downward so as to ensure the upper and lower connections. Particles 206 having a diameter of 0.1 μm to 1.0 μm larger than a spacer (not shown) that defines the thickness of the liquid crystal layer, before bonding the substrates, and compressed from above and below by up to about 1% to 10%, are preferable.

In addition, the liquid crystal device 100 has a retardation film and a polarization plate and the like arranged in predetermined directions according to an operational mode, such as the type of liquid crystal 50 used, i.e., a twisted nematic (TN) mode, a super twisted nematic (STN) mode, and a vertical aligned nematic (VAN) mode, or a normally white mode/normally black mode. However, this will be not shown in the drawings.

In the image display region of the liquid crystal display device 100 having the arrangement described above, a plurality of pixels 15 are arranged in a matrix, as shown in FIG. 3. In addition, as shown in FIG. 3, the liquid crystal display device includes a first drive IC 201 and a second drive IC 202 and a plurality of scanning lines 14 (corresponding to counter electrodes 23) and a plurality of data lines (signal lines) 13 intersecting the scanning lines 14 are arranged. Thus, the data lines 13 supply signals from the first drive IC 201 to each pixel 15 and the scanning lines 13 supply signals from the second drive IC 202 to each pixel 15. In addition, for each pixel 15, liquid crystal elements 16 (liquid crystal layer) are connected in series to the TFD elements 4 between the data lines 13 and the scanning lines 14. Furthermore, in FIG. 3, the TFD elements 4 are connected to the data lines 13 and the liquid crystal display elements 16 are connected to the scanning lines. Alternatively, the TFD elements 4 may be connected to the scanning lines 14 and the liquid crystal display elements 15 may be connected to the data lines 13.

With the circuit arrangement described above, the liquid crystal display elements 16 are driven based on a switching characteristic of the TFD elements 4, while light and dark display is performed for each pixel 15 based on the driving of the liquid crystal display element 16. Thus, image display is rendered for a display region DSP of the liquid crystal display device 100.

Next, an arrangement for the TFD elements 4 and the pixels 15, and an arrangement for the lower substrate having the TFD elements 4 (hereinafter, referred to as an element substrate) will be described in detail.

FIG. 4 is a schematic cross sectional diagram illustrating a pixel where the pixel electrodes 9, the switching elements 4, and the data lines 13 are formed, and an adjacent pixel thereto. In addition, FIG. 5 is a diagram showing a planar arrangement for each one pixel (including adjacent pixel), largely illustrating a planar positional relationship between the pixel electrodes 9 and the TFD elements 4 and the data lines 13. Moreover, FIG. 6 is a schematic cross sectional view taken along a line IV-IV of one pixel shown in FIG. 5.

As shown in FIG. 4, the data lines 13, the TFD elements 4 connected thereto, and the a light-shielding layer 13a located at a region between pixels as shown in FIG. 9 are formed in the same plane on the element substrate 110 through a base insulating layer 3, as shown in FIG. 4. Further, an interlayer insulating layer 34 is formed so as to cover these data lines 13, the TFD element 4, and the light-shielding layer 13a, and the pixel electrodes 9 are formed on the interlayer insulating layer 34. In addition, the TFD elements 4 and the pixel electrodes 9 are electrically connected through contact holes 32 formed in the interlayer insulating layer 34.

Further, on the upper substrate (hereinafter, also referred to as a counter substrate) facing the element substrate 110 through the sealant 52, a color filter CF including coloring portions R, G, and B is formed so that a planarizing layer 24 is formed to indicate the color filter (CF). In addition, stripe shaped counter electrodes (stripe electrodes) 23 are formed on the planarizing layer 24. Further, each coloring portion R, G, and B included in the color filter CF is arranged over a black matrix (BM), respectively.

The element substrate 110 may be made of a glass substrate and a plastic substrate, which has an insulating property and transparency. The data line 13 is made of Cr, and arranged at a region where the pixel electrode 9 is formed so that the data line 13 is electrically connected to the TFD element 4 arranged at the region where the pixel electrode 9 is formed. In other words, the data line 13 and the TFD element 4 are arranged so as to overlap the pixel electrode 9 in plan view.

In addition, the data lines 13 are arranged at the same distance from each of pixel electrodes (second and third pixel electrodes) adjacent to a pixel electrode overlapped with a data line (a first pixel electrode). In other words, the data line 13 is arranged in a manner to pass through a central line of one pixel electrode, and specifically, arranged so as to extend on a symmetrical axis of one pixel electrode.

The TFD element 4 connected to the data line 13 is a two-terminal-type nonlinear element in which an insulating layer is interposed with Ta and Cr, and has a so-called Back to Back structure so that the pixel electrode 9 is connected to the data line 13 through the TFD element 4, as shown in FIG. 5. Specifically, as shown in FIG. 6, the TFD element 4 has a first conductive film 6 made of Ta, an insulating film (insulating layer) 7 made of Ta₂O₅ which is formed by oxidizing a surface of the first conductive layer 6, and a second conductive film 8 made of Cr and arranged on the insulating layer 7, in this order from the element substrate 110. In addition, a portion of the second conductive layer 8 is connected to the data line 13, and the other portion is connected to a metal wiring line 35 electrically connected to the pixel electrode 9 through the contact hole 32.

The light-shielding layer 13a is arranged between the adjacent pixel electrodes 9, 9, extends parallel to the data line 13, and is formed of the same material as the data line on the same plane, as shown in FIG. 9. In other words, the light-shielding layer 13a is made of Cr and formed through the same process as a formation process of the data line 13.

The interlayer insulating layer 34 includes a transmissive insulating layer such as a silicon oxide layer or acrylic resin, and the pixel electrode 9 made of transparent conductive material such as ITO is formed on the interlayer insulating layer 34. In addition, the contact hole 32 for electrically connecting the TFD element 4 to the pixel electrode 9 overlaps the interlayer insulating layer at a portion not overlapped with the TFD element 4 (i.e., region other than right above the TFD element 4) in plan view, and is arranged so as to be overlapped with the pixel electrode 9 in plan view.

As described above, while the pixel electrodes 9 are electrically connected to the TFD elements 4 through the contact holes 32, the metal wiring lines 34 is arranged on the element substrate 110 from the TFD element 4 to the contact hole 32 so that electrical connection is performed using the metal wiring line 35. In addition, as shown in FIG. 5, the metal wiring line 35 has a contact portion 36 of an expanded diameter in plan view, at a connection portion of the contact hole 32, and is connected to the pixel electrode 9 in the contact hole 32 for the contact portion 36. In other words, the signal from the TFD element 4 is supplied to the pixel electrode 9 through the metal wiring line 35. Here, the metal wiring line 35 is made of Cr.

Further, according to the embodiment, a distance between the metal wiring line 35 and the adjacent data line 13 not electrically connected to the pixel electrode 9 is larger than a distance between the pixel electrode 9 and the adjacent data line 13. Specifically, with respect to a positional relationship between one pixel electrode (referred to as a first pixel electrode) 9 and the wiring line 35 for supplying the signal hereto and the data line (referred to as a second data line) for supplying a signal to the second pixel electrode adjacent to the first pixel electrode 9, a distance between the wiring line 35 and the second data line is formed to be larger than a distance between the first pixel electrode 9 and the second data line. With this arrangement, the signal conducting the second data line is prevented or suppressed from being carried along the wiring line 35 through the parasitic capacitance between the wiring line 35 and the second data line.

In addition, a color filter CF is arranged on the counter substrate 120 such that each coloring portion including red (R), green (G), and blue (B) is formed in a shape partitioned by black matrix (BM), as shown in FIG. 4. Further, the planarizing layer 24 made of dielectric material is formed on the inner surface of the color filter CF (liquid crystal 50), and the stripe shaped counter electrode 23 is formed on the further inner surface of the planarizing layer 24. Here, the planarizing layer 24 serves to planarize unevenness on the color filter (CF). In addition, the light-shielding layer 25 is formed that shades light between the pixels (upper and lower pixels shown in the drawing) and the contact hole 36 on the inner surface of the counter electrode 120, as shown in FIG. 10, so that the light-shielding layer 25 is made of the same material as the black matrix BM and formed in the same plane.

As described above, in the liquid crystal display device 100 according to the embodiment, the interlayer insulating layer 34 is formed so as to cover the TFD elements 4, the light-shielding layer 13a, and the data lines 13 on the element substrate 110 and the pixel electrode 9 is formed on the side of the liquid crystal layer 50 of the interlayer insulating layer 34. Therefore, excellent advantages can be obtained as described below.

First, the interlayer dielectric layer 34 can be formed so as to cover the data lines 13 and the TFD elements 4 and the pixel electrodes 9 are formed on the interlayer insulating layer 34. Therefore, the parasitic capacitance between the pixel electrodes 9 and the TFD elements 4 and/or the data lines 13 can be reduced.

In addition,. since the pixel electrodes 9, the TFD elements 4 and/or the data lines 13 are laminated with the interlayer insulating layer interposed therebetween, the pixel electrodes can be formed so as to cover the TFD elements 4 and/or the data lines 13. Consequently, the pixel electrode 9 may be largely formed, and further a large effective pixel region can be provided.

In addition, since the pixel electrodes 9 are formed so as to cover the data lines 13, the driving of the pixel electrodes 9 can be stabilized, compared with a case where the data lines 13 are arranged between the adjacent pixel electrodes 9, 9. In other words, since the data lines 13 and the pixel electrodes 9 are formed with the interlayer insulating layer interposed therebetween according to the embodiment as described above, a parasitic capacitance that can be generated between these two can be reduced. Further, even when the driving of the pixel electrode 9 is disturbed due to the effect of the parasitic capacitance, the disturbance can be still reduced. Specifically, when the pixel electrode 9 is arranged between two data lines 13, 13, a large disturbance in driving the pixel electrode 9 may be caused by the parasitic capacitance between respective data lines 13, 13. However, according to the embodiment, with the pixel electrode 9 formed so as to cover the data line 13, only the parasitic capacitance between the pixel electrode 9 and the data line 13 covered therewith substantially affects the driving, so that the disturbance can be suppressed.

In addition, while the embodiment of the invention has been described as an example that the TFD elements 4 are connected to the data lines 13 and the liquid crystal display elements 16 are connected to the scanning line 14, the liquid crystal display elements 16 may be connected to the data lines 13 and the TFD elements 4 may be connected to the scanning lines 14 (signal lines).

In addition, according to the embodiment, the data line 13 covered by the first pixel electrode 9 is arranged at the same distance from each of two pixel electrodes adjacent to the first pixel electrode 9, i.e., the second pixel electrode 9 and the third pixel electrode 9, so that even when the driving disturbance for the first pixel electrode 9 is generated, an amount thereof is negligible. In other words, the driving of the first pixel electrode 9 is affected only by the parasitic capacitance of the data line 13 covered therewith, so that the parasitic capacitance between the adjacent second pixel electrode 9 and the third pixel electrode 9 and the data lines 13, 13 arranged so as to be overlapped in plan view is significantly reduced and the effect thereof is almost negligible.

In addition, according to the embodiment, the metal wiring line 35 extending from the TFD element 4 to the contact hole 32 is covered by the interlayer insulating layer, so that the electrical connection is reliably performed from the TFD element 4 to the contact hole 32. Moreover, since the metal wiring line 35 has a large area than the aperture area of the contact hole 32, right below the contact hole 32. Thus, it is guaranteed that the formation region of the contact hole 32 is shaded from light by the metal wiring line 35, thus solving a display defect such as light leakage caused by the formation of the contact hole 32.

In addition, while the embodiment has been described as an example that the TN mode liquid crystal is used, it is desirable that the pixel electrode having a planar arrangement as shown in FIG. 7 be used when the VAN mode liquid crystal is used. The pixel electrode 9 corresponding to the VAN mode shown in FIG. 7 includes a plurality of island-shaped portions 9a having approximately octagonal in plan view, and a connection portion 9b having a branch shape that connects these island-shaped portions 9a, in which vertically aligned liquid crystal molecules are aligned and divided within each island-shaped portion 9a.

The VAN mode liquid crystal display device includes a liquid crystal 50 made of liquid crystal material having a negative dielectric anisotropy. Therefore, the liquid crystal molecule is tilted from an initial alignment state, i.e., vertical to the substrate plane by applying electric field. Thus, if nothing is twisted (pre-tilt is not provided), it is difficult to control a direction in which the liquid crystal molecule falls down and the alignment disturbance (disclination) is generated so that the display defect such as light leakage occurs, thus degrading display quality. For this reason, with respect to employing the VAN mode, it is a critical factor to control an alignment direction of the liquid crystal molecule upon applying electric field.

Here, in an example shown in FIG. 7, the pixel electrodes includes island-shaped portions 9a in an approximately right octagon, as an essential part, to control the alignment direction of the liquid crystal molecule for each island-shaped portion 9a. Specifically, a biased electric field is generated between the pixel electrode 9 notched in octagon and the counter electrode 23, and the pre-tilt is provided according to the biased electric field. As a result, the liquid crystal molecule is tilted in substantially concentric shape from a center of the approximately octagonal island-shaped portion 9a to the outside. Further, the contact hole 32 provides a concave portion to the interposed plane of the liquid crystal 50, which may be designed as a center of the island-shaped portion 9a. In this case, it is further ensured that the pre-tilt is provided with a center of the contact hole 32.

Even though the invention has been described with respect to the liquid crystal display device as an embodiment of the electro-optical device, the invention is not limited hereto and may be used in a reflective liquid crystal display device and a transflective liquid crystal display device capable of both reflection and transmission display. Further, in addition to the liquid crystal display device (liquid crystal device), the invention may be used in an electro luminescent (EL) device, an electron-emitting element (a field emission display and a surface-conduction electron-emitter display) and the like.

Electronic Apparatus

A specific example of an electronic apparatus having the liquid crystal display device according to the embodiment will be described.

FIG. 8 is a perspective view showing an example of a cellular phone. In FIG. 8, a reference numeral 500 indicates a main body of the cellular phone and a reference numeral 501 indicates a display unit using the above-described liquid crystal display device. The electronic apparatus has a display unit using the liquid crystal display device of the present embodiment, thus providing an electronic apparatus having a maximum effective pixel area without degradation of the display characteristic.

In addition, the electronic apparatus herein is not limited to the cellular phone, but the invention may be very appropriately used as an image display device such as an electronic book, a personal computer, a digital still camera, a liquid crystal TV, a viewfinder type or direct-view type video tape recorder, a car navigation device, a pager, an electronic organizer, a calculator, a word processor, a workstation, a video phone, a POS terminal and an apparatus having a touch panel and the like, so that display having an excellent visibility is enabled for any electronic apparatus.

1. An electro-optical device comprising:
a substrate;
switching elements, formed on the substrate and having a first conductive layer, a second conductive layer, and an insulating layer interposed between the first conductive layer and the second conductive layer, the switching elements being nonlinear elements;
signal lines formed on the substrate that supply signals to the switching elements;
an interlayer insulating layer formed on the substrate so as to cover the signal lines and the switching elements; and
pixel electrodes formed on the interlayer insulating layer and electrically connected to the switching elements, the pixel electrodes overlapping the signal lines in plan view.

2. The electro-optical device according to claim 1,
wherein the signal lines are arranged at the same distance from a second pixel electrode and a third pixel electrode, respectively, both adjacent to a first pixel electrode arranged to be overlapped with the signal line in plan view.

3. The electro-optical device according to claim 1,
wherein the switching element and the pixel electrode are connected via a contact hole formed on the interlayer insulating layer,
wherein wiring lines arranged to extend from the switching elements to the contact hole are formed on the substrate to cover the interlayer insulating layer, and
wherein the switching elements are electrically connected to the pixel electrodes via the wiring lines.

4. The electro-optical device according to claim 3, wherein a distance between adjacent signal lines that are not electrically connected to the pixel electrode and the wiring lines is larger than that between the adjacent signal lines and the pixel electrodes.

5. The electro-optical device according to claim 3, wherein the wiring lines are made of a light-shielding member.

6. The electro-optical device according to claim 1,
wherein a light-shielding layer extending parallel to the signal lines is formed between the adjacent pixel electrodes, and
wherein the light-shielding layer is made of the same material as the signal lines and is formed in the same plane.

7. The electro-optical device according to claim 1,
wherein the interlayer insulating layer is a planarizing layer.

8. The electro-optical device according to claim 1, further comprising:
a counter substrate facing the substrate,
wherein liquid crystal having a negative dielectric anisotropy is interposed between the substrate and the counter substrate.

9. An electro-optical device comprising:
a first substrate and a second substrate facing each other;
switching elements formed on the first substrate;
signal lines formed on the first substrate and connected to the switching element;
an interlayer insulating layer formed on the first substrate so as to cover the signal line and the switching element;
pixel electrodes formed on the interlayer insulating layer and electrically connected to the switching device via a contact hole, the pixel electrodes overlapping the signal lines in plna view; and
a light-shielding layer formed on the second substrate and overlapping the contact hole in plan view.

10. The electro-optical device according to claim 9, wherein the light-shielding layer does not overlap the switching elements in plan view.

11. An electronic apparatus having the electro-optical device according to claim 1.
